(19) United States
(12) Patent Application Publication
(10) Pub. No.: US 2016/0019202 A1
(43) Pub. Date: Jan. 21, 2016

(54) SYSTEM, METHOD, AND APPARATUS FOR REVIEW AND ANNOTATION OF AUDIOVISUAL MEDIA CONTENT

(71) Applicants: Charles Adams, Los Angeles, CA (US); Soorena Salari, Alta Loma, CA (US)

(72) Inventors: Charles Adams, Los Angeles, CA (US); Soorena Salari, Alta Loma, CA (US)

(21) Appl. No.: 14/805,356

(22) Filed: Jul. 21, 2015

Related U.S. Application Data
(60) Provisional application No. 62/027,157, filed on Jul. 21, 2014.

(51) Int. Cl. G06F 17/27

(52) U.S. Cl. CPC G06F 17/2705

(57) ABSTRACT

An apparatus for reviewing and annotating audiovisual media content includes a transcript parser, syncing module, video module, transcript viewer module, annotation module, and data module. The transcript parser parses a transcript of a video. The syncing module synchronizes the video with the transcript. The video module streams the video to a user. The transcript viewer module displays the transcript to the user in sync with the video. The annotation module assigns a tag to a portion of the video in response to the user marking with the tag a portion of the transcript in sync with the portion of the video. The data module stores information pertaining to the portion of the transcript marked by the user.

### FIELD

This subject matter disclosed herein relates to reviewing and annotating audiovisual media content and more particularly relates to reviewing and annotating audiovisual media in conjunction with a transcript of the audiovisual media.

### BACKGROUND

A traditional media industry such as television provides transcriptions of its media content so that media consumers can search and locate topics of interest within a particular media segment. Other industries also generate and use audiovisual content where it is necessary to review and annotate the media for future use by multiple users. Collaborative tools for reviewing and annotating audiovisual media make it easier and more efficient, in time and/or cost, for users in these professions to review, tag, and annotate media for later use.

### BRIEF SUMMARY

An apparatus for reviewing and annotating audiovisual media content is disclosed, the apparatus including a transcript parser, syncing module, video module, transcript viewer module, annotation module, and data module. The transcript parser parses a transcript of a video. The syncing module synchronizes the video with the transcript. The video module streams the video to a user. The transcript viewer module displays the transcript to the user in sync with the video. The annotation module assigns a tag to a portion of the video in response to the user marking with the tag a portion of the transcript in sync with the portion of the video. The data module stores information pertaining to the portion of the transcript marked by the user.

In one embodiment, the apparatus also includes a messaging module that transmits the information pertaining to the portion of the transcript marked by the user to one or more other users. In another embodiment, the apparatus also includes a search module that identifies one or more portions of the transcript in response to search criteria provided by the user. In a certain embodiment, the annotation module further assigns a tag to the one or more identified portions of the transcript. In an embodiment, the video module further displays to the user one or more documents referenced in the transcript of the video. In a particular embodiment, the video module streaming the video to the user includes streaming one or more portions of the video to the user. In this embodiment, the one or more portions of the video share one or more tags.

A method for reviewing and annotating audiovisual media content is disclosed. The method parses a transcript of a video, synchronizes the video with the transcript, streams the video to a user, displays the transcript to the user in sync with the video, assigns a tag to a portion of the video in response to the user marking with the tag a portion of the transcript in sync with the portion of the video, and stores information pertaining to the portion of the transcript marked by the user.

In one embodiment, the method also transmits the information pertaining to the portion of the transcript marked by the user to one or more other users. In another embodiment, the method also identifies one or more portions of the transcript in response to search criteria provided by the user. In a certain embodiment, the method includes assigning a tag to the one or more identified portions of the transcript. In an embodiment, the method further displays to the user one or more documents referenced in the transcript of the video. In a particular embodiment, streaming the video to the user includes streaming one or more portions of the video to the user. In this embodiment, the one or more portions of the video share one or more tags.

A computer program product for reviewing and annotating audiovisual media content is disclosed, the computer program product configured to parse a transcript of a video, synchronize the video with the transcript, stream the video to a user, displays the transcript to the user in sync with the video, assign a tag to a portion of the video in response to the user marking with the tag a portion of the transcript in sync with the portion of the video, and store information pertaining to the portion of the transcript marked by the user.

In one embodiment, the computer program product is also configured to transmit the information pertaining to the portion of the transcript marked by the user to one or more other users. In another embodiment, the computer program product is also configured to identify one or more portions of the transcript in response to search criteria provided by the user. In a certain embodiment, the computer program product is also configured to assign a tag to the one or more identified portions of the transcript. In an embodiment, computer program product is also configured to display to the user one or more documents referenced in the transcript of the video. In a particular embodiment, streaming the video to the user includes streaming one or more portions of the video to the user. In this embodiment, the one or more portions of the video share one or more tags.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for reviewing and annotating audiovisual media content;

FIG. 2 is a schematic block diagram illustrating one embodiment of an apparatus for reviewing and annotating audiovisual media content;

FIG. 3 is a schematic block diagram illustrating another embodiment of an apparatus for reviewing and annotating audiovisual media content;

FIG. 4 is a schematic flow chart diagram illustrating one embodiment of a method for reviewing and annotating audiovisual media content;

FIG. 5 is a schematic flow chart diagram illustrating another embodiment of a method for reviewing and annotating audiovisual media content;

FIG. 6 is a schematic flow chart diagram illustrating still another embodiment of a method for reviewing and annotating audiovisual media content;

FIG. 7 is a schematic flow chart diagram illustrating yet another embodiment of a method for reviewing and annotating audiovisual media content; and

FIG. 8 is a schematic flow chart diagram illustrating a further embodiment of a method for reviewing and annotating audiovisual media content.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

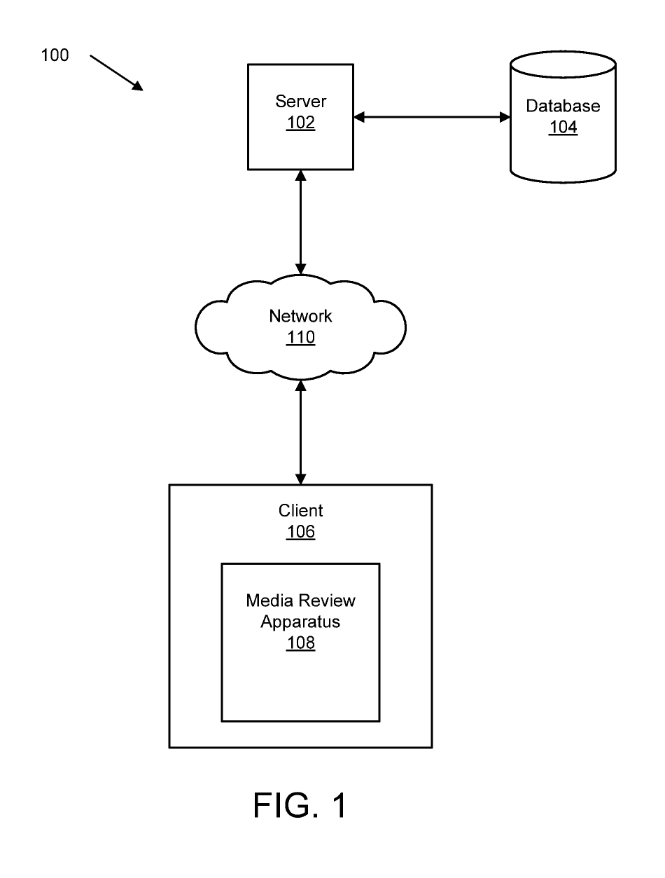

FIG. 1 is a schematic block diagram illustrating one embodiment of a system for reviewing and annotating audiovisual media content. The system 100 includes a server 102 with database 104 connected to a client 106 with a media review apparatus 108 through a network 110, which are described further below.

The system 100 includes a client 106 in communication with a server 102 having a database 104 through a network 110. The server 102 may be any computer accessible by a client 106 over a network 110, including but not limited to a gateway, router, mainframe server, streaming media server, or proxy server. For example, the server 102 can be a gateway that connects the client 106 to the Internet, cloud-based servers, or another client 106. The network 110 connecting the server 102 and the client 106 may include a local area network (“LAN”), a wide area network (“WAN”), a wireless network, a cellular network, the Internet, or the like. The database 104 may be any form of data storage, including but not limited to a relational database or a flat file. The database 104 can be hosted on the server 102 or a separate server.

The client 106 may be an electronic device or a software application running on an electronic device. The client 106 as an electronic device may be a smartphone, a tablet computer, a laptop computer, a desktop computer, a digital media player (e.g., Apple TV), a network appliance, a gaming console (e.g., PlayStation, Xbox, Wii) or the like. The client 106 as a software application may be web application running within a web browser on an electronic device or a standalone application running on an electronic device.

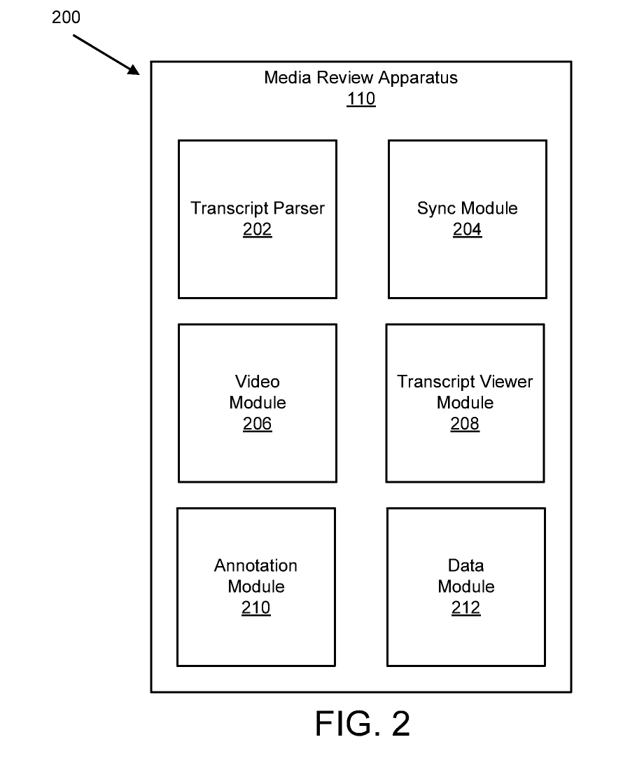

The media review apparatus 108 may reside solely on client 106. In one embodiment, the media review apparatus 108 resides in part on the server 102 and in part on the client 106. In an embodiment, the media review apparatus 108 resides in part on the server 102 and in part on the client 106. In another embodiment, the media review apparatus 108 resides in part on the server 102, in part on the client 106, and also in part on a different server hosting the database 104, such as a streaming media server. The media review apparatus 108 is described in more detail with respect to the apparatus 200 in FIG. 2.

FIG. 2 is a schematic block diagram illustrating one embodiment of an apparatus for reviewing and annotating audiovisual media content. The apparatus 200 includes a transcript parser 202, a sync module 204, a video module 206, a transcript viewer module 208, an annotation module 210, and a data module 212, which are described below.

The transcript parser 202, parses a transcript of a video into a database. In one embodiment, the transcript parser 202 parses each word of a video transcript as an entry into a database table. In another embodiment, the transcript parser 202 parses each word and its related forms as an entry in a database table. A related form for a word can be its singular or plural form (for a noun), a past/present/future tense (for a verb), or some other form (e.g., root). In a certain embodiment, the transcript parser 202 parses each word and its translation equivalent as an entry in a database table. A translation equivalent of a word is the word's equivalent in a foreign language (e.g., “casa” is Spanish equivalent for “house”).

The sync module 204 synchronizes a video with a transcript of the video. In one embodiment, the sync module 204 synchronizes the video with the transcript by creating an index associating each word in the transcript of the video with one or more timestamps of the video. In this embodiment, the index contains an entry for each word in the transcript of the video, and each entry is associated with one or more timestamps of the video where the word is spoken. In another embodiment, where the transcript of the video is organized by page and line numbers, the sync module 204 synchronizes the video with the transcript by creating an index associating each line of the transcript with a timestamp of the video. In this embodiment, the index contains an entry for each line in the transcript of the video, and each entry is associated with a timestamp of the video where the first word in the line is spoken. The video, transcript, and index may be stored on the server 102 or the database 104.

The sync module 204 also links one or more documents referenced in the transcript of the video with a copy of the one or more documents stored on either the server 102, the database 104, the client 106, or another server. In one embodiment, the sync module 204 links a document referenced in the transcript of the video by modifying each entry for one or more words in the transcript referencing the document to contain a link to the location of the document. In another embodiment, the sync module 204 links a document referenced in the transcript of the video by modifying each entry for one or more lines in the transcript containing a reference to the document to contain a link to the location of the document.

The video module 206 streams one or more videos to a user. To “stream” a video, as used herein, refers to delivering audiovisual data using various transfer protocols other than hypertext transfer protocol (HTTP), including but not limited to protocols such as real-time streaming protocol (RSMP), real-time messaging protocol (RTMP), Microsoft media services (MMS), or QuickTime. Streaming video has several advantages compared to traditional progressive downloads. A progressive download is a bulk download of a video file to the end user's computer, thus creating a temporary copy of the video on the computer that the user can view repeatedly without having to download it again. Thus, video playback can begin as soon as there is enough of the video file has been downloaded onto the local machine, giving the illusion of video streaming. However, a user cannot skip to parts of a video that has not yet been downloaded. In contrast, streaming video allows a user to send control messages to the streaming media server, such as “play,” “stop,” and “seek.” As such, a user can request the delivery of a part of a streaming video without having to download any preceding portion of the video. Thus, a user may conveniently begin playback at any point of a streaming video and can skip directly to any point in the video. Besides convenience, streaming video also makes efficient use of bandwidth because only requested portions of a video will be delivered as opposed to a download of the entire video file. In addition, with streaming video, the video data is discarded and not stored on the local machine, allowing a video content owner more control of its content.

In one embodiment, the video module 206 streams one or more videos to the user in response to user input. The video module 206 can stream the one or more videos to a user as a single uninterrupted video even if the video is actually comprised of multiple video files. The video module 206 can stream the one or more videos to the user from the beginning of a video or anywhere in the middle of the video. The video module 206, in an embodiment, can stream the video to a web browser through a browser plugin. Alternatively, the video module 206 can stream the video in a standalone application. In addition to streaming the video, the video module 206 displays visual elements that allow the user to control video playback. Via these visual elements, the video module 206 can receive user input to control video playback, including commands such as “play,” “pause,” “stop,” “seek,” “fast forward,” and “rewind/reverse.” In another embodiment, the video module 206 streams the video to the user includes streaming one or more segments of the video to the user. The video segments streamed to the user can be non-contiguous and/or out of chronological order. For example, in response to user input, the video module 206 can stream a video from the beginning, skip to streaming the end of the video, and then skip to streaming from somewhere in the middle of the video. As another example, the video module 206 can stream all segments of a video that have been assigned the same tag or a related tag. Assigning a tag to a segment of a video is described further below in relation to the annotation module 210. In yet another example, the video module 206 can stream all segments of a video where the person in the video (e.g., a witness) has a certain facial expression conveying a specific emotion. Emotion evaluation of a person in a video is described further below in relation to the emotion evaluation module 306.

The video module 206 also displays one or more documents referenced in the transcript of the video. In one embodiment, the video module 206 displays the one or more documents referenced in the transcript of the video as the video streams. In this embodiment, the video module 206 displays a referenced document when the portion of the video corresponding to the transcript is streamed to the user within the same pane/window as the video or within a separate pane/window. In another embodiment, the video module 206 displays the one or more documents referenced in the transcript of the document in lieu of the video when the portion of the transcript containing the reference to a document is displayed to the user. In some embodiments, the video module 206 displays a referenced document in response to user input. In these embodiments, the video module 206 will initially only display a link to a document referenced in the transcript of the video and will display the referenced document when the user selects the link. The video module 206 can display a referenced document in its native format or an image of the document (e.g., PDF, TIFF). For example, during the playback of a deposition video, the video module 206 may display a link to a deposition exhibit when the exhibit is being used during the deposition. If the user selects the link, the video module 206 will then display the deposition exhibit in conjunction with the deposition video in a separate pane/window.

The transcript viewer module 208 displays the transcript of the video to the user in sync with the streaming video. The transcript may be displayed in a separate window/pane from the video so that a user may follow review the accuracy of the transcript and/or better understand words spoken in the video. For example, having a transcript of a deposition video when watching the deposition video is useful when the deponent or attorney has a heavy accent, does not speak clearly, or if there are multiple persons speaking on the record. Another example could be reviewing a police interview with a suspect or witness with a copy of the interview. In an embodiment, the transcript viewer module 208 displaying the transcript of the video to the user in sync with the streaming video includes scrolling a portion of the transcript as the video streams. The portion of the transcript displayed may vary. In some cases, the transcript viewer module 208 can display the portion of the transcript in sync with the streaming video as well as portions of the transcript immediately preceding and following the synced portion of the transcript. In certain embodiments, the transcript viewer module 208 uses visual cues to help the user follow along with the transcript. Such visual cues can include highlighting the synced portion of the transcript, enlarging the synced portion of the transcript, changing the font or color of the synced portion of the transcript, or a cursor that moves through the transcript in sync with the streaming video.

In some embodiments, the transcript viewer module 208 displays multiple copies of the transcript of the video to the user. In these embodiments, the transcript viewer module 208 displays each copy of the transcript in a separate window/pane, but at least one copy of the transcript would not necessarily be displayed in sync with the streaming video. An advantage of displaying multiple copies of the transcript is flexibility and convenience for the user in reviewing the transcript. Displaying multiple copies of the transcript can allow a user to annotate a transcript for further review while continuing the stream the video, thus saving time. Displaying multiple copies of the transcript can also allow a user to review other parts of the transcript while continuing to stream the video. For example, if a deponent's testimony streaming in a deposition video contradicts his earlier testimony, a user can navigate through one of the multiple copies of the transcript displayed to locate the earlier testimony. Similarly, if a crime suspect's statement streaming in a video of his interview with law enforcement contradicts his earlier statements in the same video, a user can navigate through another copy of the displayed transcript to locate the earlier statements.

The annotation module 210 assigns a tag to a segment of the video in response to the user marking with the tag a segment of the transcript in sync with the segment of the video. The tag may be an existing tag previously created by a user or dynamically created by the annotation module 210 in response to user generated criteria. During a review of a video, it is desirable for users to tag one or more video segments for further review by other users or later use. For example, when an attorney reviews a deposition video, he may wish to tag all parts of the deposition testimony where the deponent answers questions regarding an issue, claim, and/or defense. These designations may be later used by the same attorney or others in a written motion, at trial, or to assist in drafting discovery requests. In one embodiment, a user may select (e.g., highlight) a portion of the transcript and assign one or more tags to the highlighted portion. In response, the annotation module 210 will assign the same one or more tags to the segment of the video corresponding to the portion of the transcript. In doing so, the annotation module 210 creates one or more entries in the database 104 associating each of the one or more user-assigned tags with the segment of the video corresponding to the portion of the transcript (e.g., beginning and ending timestamp of the video). In another embodiment, the user may select (e.g., highlight) multiple portions of the transcript and assign the same one or more tags to these portions of the transcript. In response, the annotation module 210 will assign the same one or more tags to the multiple video segments corresponding to these portions of the transcript, creating one or more entries in the database 104. In the aforementioned embodiments, the portions of the transcript selected by the user may be the result of automated searches conducted by the user.

A portion of a transcript may be assigned a plurality of tags by the annotation module 210. In addition, the annotation module 210 may associate a tag with one or more other related tags. For example, a user may assign a first tag to different parts of a transcript, and then assign a second tag to a subset of the parts of the transcript having the first tag. In this example, the first tag may represent a cause of action and the second tag may represent an element of the cause of action.

The annotation module 210 also allows users to create, edit, and delete notes associated with the tags created by the user. These annotations may be stored in the database and associated with a particular tag and/or a specific portion of the video transcript. Annotations or notes made by a user may be public (visible to all other users), semi-private (visible to certain designated users), or private (not visible to any other users).

As described above, the video module 206 can stream all portions of one or more videos having identical tags created by the annotation module 210. The video module 206 can stream the one or more videos as a single video to users so that a user can review all the relevant videos related to a specific issue or topic. Users may use the video module 206 to create playlists focusing on multiple tags created by the annotating module 210.

The data module 212 stores information pertaining to the portion of a transcript marked by a user. As stated above, it is desirable for users to tag one or more video segments for further review or later use. Thus, it would be advantageous for users to be able to annotate the transcript of the video with his or her notes. The data module 212 stores annotations made by users pertaining to a specific part of a transcript. In one embodiment, after a user has marked a part of a transcript (e.g., highlighting a passage), the user may enter annotations pertaining to the marked passage. The data module 212 stores the annotations in the database 104 by associating the annotations with the tag used by the user to mark that passage. The annotations may include text, images, or links to other files. A user may view and edit existing annotations. If a user edits an existing annotation, the data module 212 will store the revised annotation in the database 104.

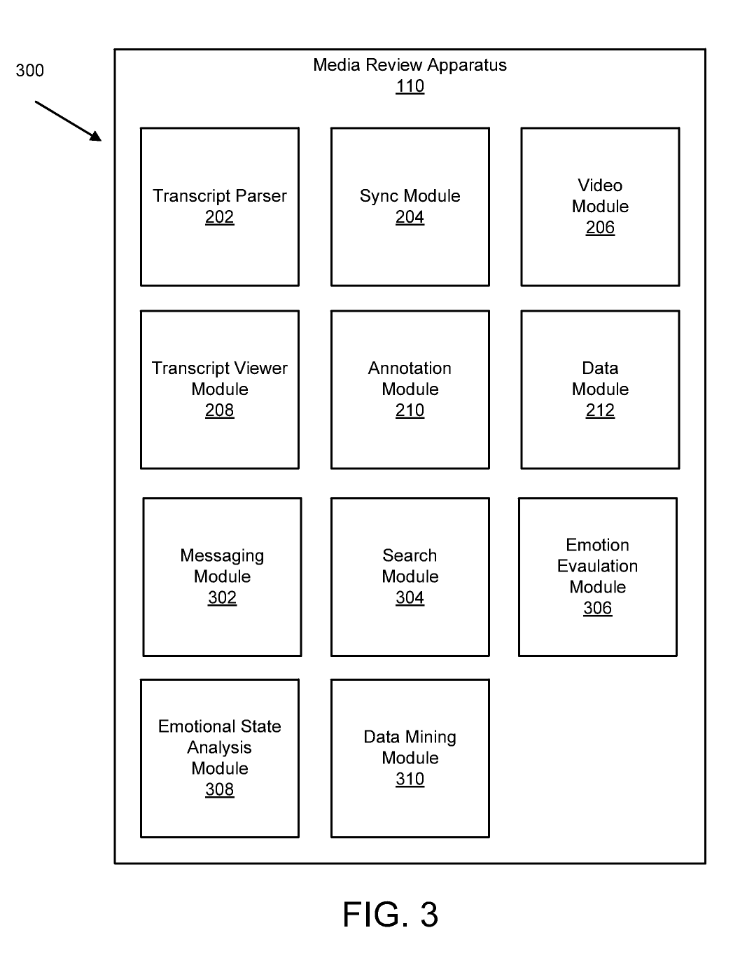

FIG. 3 is a schematic block diagram illustrating another embodiment of an apparatus for reviewing and annotating audiovisual media content. The apparatus 300 includes a sync module 204, a video module 206, a transcript viewer module 208, an annotation module 210, a data module 212, a messaging module 302, a search module 304, an emotion evaluation module 306, an emotional state analysis module 308, and a data mining module 310. The sync module 204, a video module 206, a transcript viewer module 208, an annotation module 210, a data module 212 are substantially similar to those described above in relation to FIG. 2. The messaging module 302, search module 304, emotion evaluation module 306, emotional state analysis module 308, and data mining module 310 are described below.

The messaging module 302 transmits information pertaining to the portion of a transcript marked by a user to one or more other users. In one embodiment, the messaging module 302 is a built-in web e-mail form that allows a user to e-mail his annotations for a marked passage to others. In another embodiment, the messaging module 302 initiates a standalone e-mail application on the client 106 containing the user's annotations that the user can send to others. In yet another embodiment, the messaging module allows a user to text his annotations for a marked passage to others.

The search module 304 identifies one or more portions of the transcript of the video in response to search criteria (e.g., keywords, emotional states) provided by the user. In one embodiment, the search module 304 includes a keyword search box that receives one or more keywords from a user and searches the transcript for all instances of the one or more keywords. In certain embodiments, the annotation module 210 will assign the keyword as a tag to the transcript passages identified by the search module 304 using the keyword.

The emotion evaluation module 306 determines one or more visual emotional states of a person in the video. In one embodiment, the emotion evaluation module 306 determines one or more visual emotional states of a person in the video by analyzing the facial expressions of the person in the video. A person's facial expression may convey multiple emotional states at the same time. These emotional states includes at least the following: joy, sadness, anger, surprise, fear, contentment, disgust, frustration, and confusion. Each emotional state has a valence, or attractiveness, which can be either positive, negative, or neutral. For example, the emotions joy and contentment have a positive valence while anger and fear have a negative valence. Valence can be expressed numerically. In one embodiment, valence may be based upon the Facial Action Coding System and micro expressions. In certain embodiments, the emotion evaluation module 306 also rates the intensity of a person's visual emotional state. For example, the emotion evaluation module 306 may assign a numerical ranking to how happy a person in the video is.

The emotion evaluation module 306 also rates a perception of a person in the video. The perception of a person can be expressed in different ways. For example, the perception of a person can be expressed on a numerical scale. As another example, the perception of a person can be expressed as positive, negative, or neutral. The emotion evaluation module 306 rates the perception of a person in the video by measuring the valence of the person's visual emotional state over time. Thus, if the emotion evaluation module 306 determines that a person in a video has more emotional states with a positive valence than negative valence, it will rate the person as having a positive perception. Similarly, if the emotion evaluation module 306 determines that a person in a video has more emotional states with a negative valence than a positive valence, it will rate the person as having a negative perception. In one embodiment, the emotion evaluation module 306 rates a perception of a person in the video over the entire video. In another embodiment, the emotion evaluation module 306 rates a perception of a person in the video over a segment of the video.

In one embodiment, the video module 206 displays graphics illustrating the one or more visual emotional states of a person in the video. For example, the video module 206 can display graphics illustrating how a person's visual emotional state changed over time in the video, or the percentage of time a person's visual emotional state was sad. In another embodiment, the video module 206 displays graphics illustrating the perception of a person in the video. For example, the video module 206 can display graphics illustrating the valence or a perception of a person at a specific point or during a certain time period in the video, or the cumulative perception of a person in the video.

The emotion evaluation module 306 can also determine an expected emotional state of a person conveyed by the person's statements in a transcript. In one embodiment, the emotion evaluation module 306 determines the expected emotional state of a person's statements in a transcript through analyzing the person's written statements in the transcript through natural language processing to understand their meaning and then determining an expected emotional state of the person based upon the meaning of the statement. Thus, the emotion evaluation module 306 can determine the visual emotional state of a person in the video by analyzing his or her facial expression and the expected emotional state of a person through analyzing the written transcript of the person's verbal statements.

The emotional state analysis module 308 detects conflicts between a visual emotional state and an expected emotional state of a person. In one embodiment, the emotional state analysis module 308 detects a conflict if the visual emotional state and expected emotional state of a person does not match exactly (e.g, anger v. happiness; disgust v. sadness). In another embodiment, the emotional state analysis module 308 detects a conflict if the valence of the visual emotion state and the valence of the expected emotional state of a person does not match (e.g., positive v. negative). In a further embodiment, even if the visual emotional state and expected emotional state of a person matches, the emotional state analysis module 308 detects a conflict if the intensity of the visual emotional state does not match the intensity of the expected emotional state.

The data mining module 310 analyzes the one or more transcripts to identify concepts and/or relationship expressed within them. For example, the data mining module 310 may analyze a deposition transcript to identify inconsistent statements made by a deponent. As another example, the data mining module 310 may analyze a deposition transcript to identify the individuals mentioned in the transcript and possible relationships between each of the individuals. In another example, the data mining module 310 may analyze multiple deposition transcripts to determine what each deponent said about a particular object, person, or event.

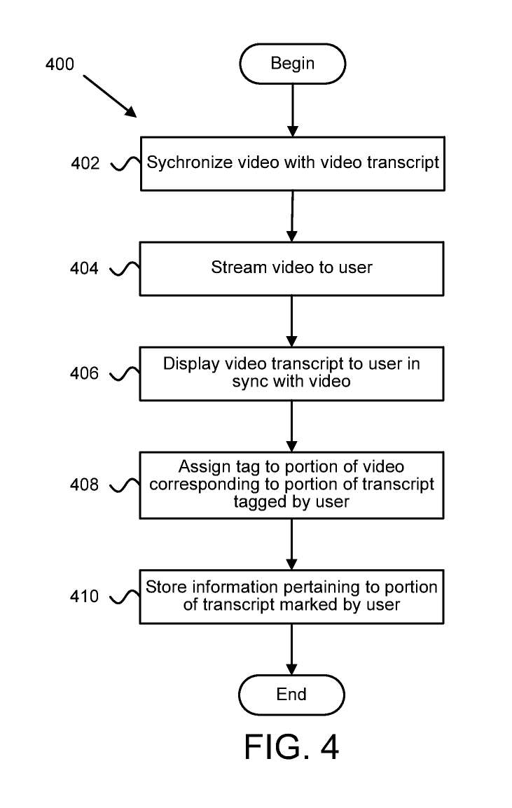

FIG. 4 is a schematic flow chart diagram illustrating one embodiment of a method for reviewing and annotating audiovisual media content. The method 400 begins and synchronizes 402 a video with a transcript of the video. The method 400 streams 404 the video to a user. The method 400 displays 406 the transcript of the video to the user in sync with the video. The method 400 assigns 408 a tag to the portion of the video in response to the user marking with the tag a portion of the transcript in sync with the video. The method 400 stores 410 information pertaining to the portion of the transcript marked by the user and the method 400 ends.

The method 400 determines 402 the data loss rate pertaining to a datastream between a server 102 and a client 106. The method 400 determines 404 whether the data loss rate is greater than or equal to a threshold. If the data loss rate is greater than or equal to the threshold, the method 400 causes 406 the server 102 and the client 106 to send to and receive from each other data packets encoded using random linear network coding and the method 400 ends. If the data loss rate is not greater than or equal to the threshold, the method 400 causes 408 the server 102 and the client 106 to stop sending and receiving data packets encoded using random linear network coding between each other and the method 400 ends.

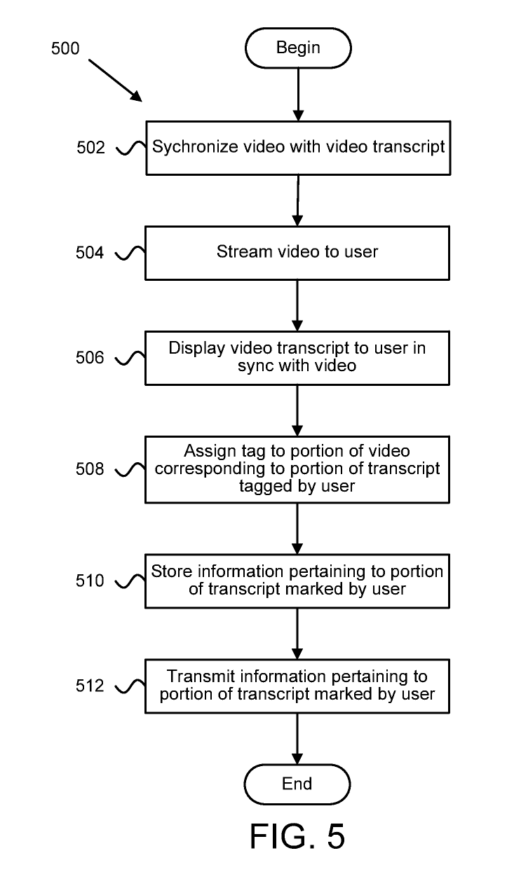

FIG. 5 is a schematic flow chart diagram illustrating another embodiment of a method for reviewing and annotating audiovisual media content. The method 500 begins and synchronizes 502 a video with a transcript of the video. The method 500 streams 504 the video to a user. The method 500 displays 506 the transcript of the video to the user in sync with the video. The method 500 assigns 508 a tag to the portion of the video in response to the user marking with the tag a portion of the transcript in sync with the video. The method 500 stores 510 information pertaining to the portion of the transcript marked by the user. The method 500 transmits 512 the information pertaining to the portion of the transcript marked by the user to one or more other users and the method 500 ends.

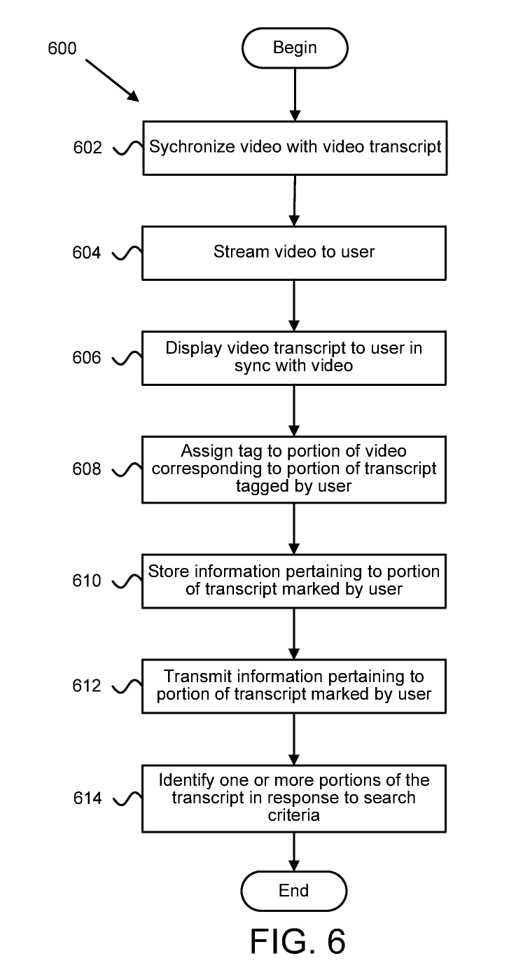

FIG. 6 is a schematic flow chart diagram illustrating still another embodiment of a method for reviewing and annotating audiovisual media content. The method 600 begins and synchronizes 602 a video with a transcript of the video. The method 600 streams 604 the video to a user. The method 600 displays 606 the transcript of the video to the user in sync with the video. The method 600 assigns 608 a tag to the portion of the video in response to the user marking with the tag a portion of the transcript in sync with the video. The method 600 stores 610 information pertaining to the portion of the transcript marked by the user. The method 600 transmits 612 the information pertaining to the portion of the transcript marked by the user to one or more other users. The method 600 identifies 614 one or more portions of the transcript in response to search criteria provided by the user and the method 600 ends.

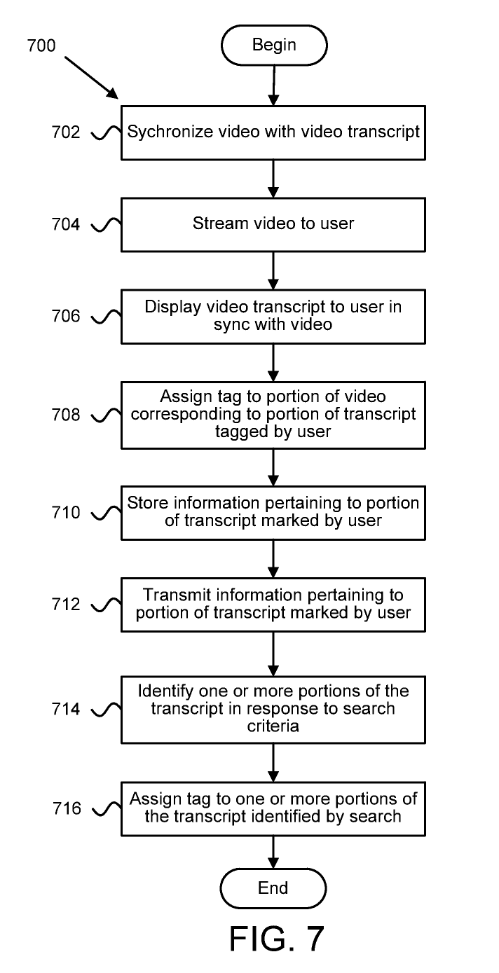

FIG. 7 is a schematic flow chart diagram illustrating yet another embodiment of a method for reviewing and annotating audiovisual media content. The method 700 begins and synchronizes 702 a video with a transcript of the video. The method 700 streams 704 the video to a user. The method 700 displays 706 the transcript of the video to the user in sync with the video. The method 700 assigns 708 a tag to the portion of the video in response to the user marking with the tag a portion of the transcript in sync with the video. The method 700 stores 710 information pertaining to the portion of the transcript marked by the user. The method 700 transmits 712 the information pertaining to the portion of the transcript marked by the user to one or more other users. The method 700 identifies 714 one or more portions of the transcript in response to search criteria provided by the user. The method 700 assigns 716 a tag to one or more portions of the transcript identified by the search and the method 600 ends.

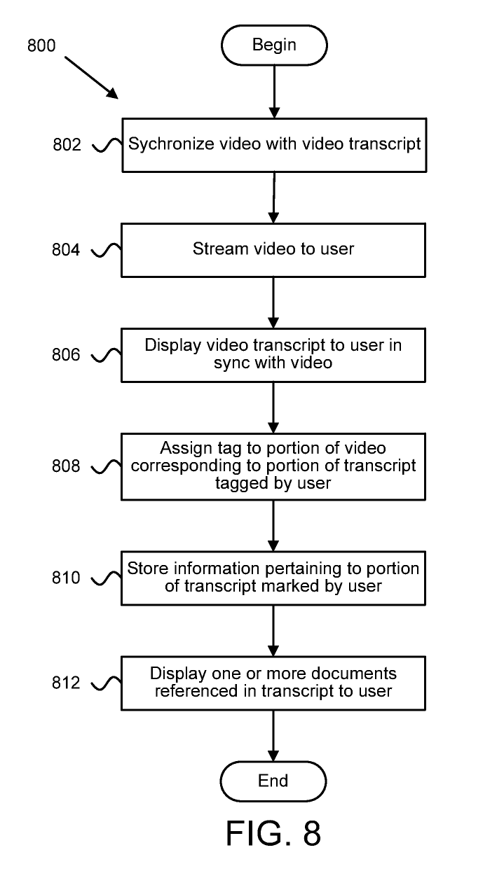

FIG. 8 is a schematic flow chart diagram illustrating a further embodiment of a method for reviewing and annotating audiovisual media content. The method 800 begins and synchronizes 802 a video with a transcript of the video. The method 800 streams 804 the video to a user. The method 800 displays 806 the transcript of the video to the user in sync with the video. The method 800 assigns 808 a tag to the portion of the video in response to the user marking with the tag a portion of the transcript in sync with the video. The method 800 stores 810 information pertaining to the portion of the transcript marked by the user. The method 800 displays 812 one or more documents referenced in the transcript of the video and the method 800 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for reviewing and annotating audiovisual media content comprising:
a transcript parser that parses a transcript of a video into a database;
syncing module that synchronizes the video with the transcript;
a video module that streams the video to a user;
a transcript viewer module that displays the transcript to the user, wherein the transcript displays in sync to the video;
an annotation module that assigns a tag to a portion of the video in response to the user marking with the tag a portion of the transcript in sync to the portion of the video; and
a data module that stores information pertaining to the portion of the transcript marked by the user;
wherein at least a portion of the transcript parser, the syncing module, the video module, the transcript module, the annotation module, and the data module comprise one or more of hardware and executable code, the executable code stored on one or more computer readable storage media.

2. The apparatus of claim 1, further comprising a messaging module that transmits the information pertaining to the portion of the transcript marked by the user to one or more other users.

3. The apparatus of claim 1, further comprising a search module that identifies one or more portions of the transcript in response to search criteria provided by the user.

4. The apparatus of claim 3, wherein the annotation module further assigns a tag to the one or more identified portions of the transcript.

5. The apparatus of claim 1, wherein the video module further displays to the user one or more documents referenced in the transcript of the video.

6. The apparatus of claim 1, wherein the video module streaming the video to the user comprises streaming one or more portions of the video to the user.

7. The apparatus of claim 6, wherein the one or more portions of the video share one or more tags.

8. A method for reviewing and annotating audiovisual media content comprising:
parsing a transcript of a video into a database;
synchronizing the video with the transcript;
streaming the video to a user;
displaying the transcript to the user, wherein the transcript displays in sync to the video;
assigning a tag to a portion of the video in response to the user marking with the tag a portion of the transcript in sync to the portion of the video; and
storing information pertaining to the portion of the transcript marked by the user.

9. The method of claim 8, further comprising transmitting the information pertaining to the portion of the transcript marked by the user to one or more other users.

10. The method of claim 8, further comprising identifying one or more portions of the transcript in response to search criteria provided by the user.

11. The method of claim 10, further comprising assigning a tag to the one or more identified portions of the transcript.

12. The method of claim 8, further comprising displaying to the user one or more documents referenced in the transcript of the video.

13. The method of claim 8, wherein streaming the video to the user comprises streaming one or more portions of the video to the user.

14. The method of claim 13, wherein the one or more portions of the video share one or more tags.

15. A computer program product for reviewing and annotating audiovisual media content, the computer program product comprising a computer readable storage medium having program instructions embodied therewith, the program instructions readable/executable by a processor to cause the processor to:
parse a transcript of a video into a database;
synchronize the video with the transcript;
stream the video to a user;
display the transcript to the user, wherein the transcript displays in sync to the video;
assign a tag to a portion of the video in response to the user marking with the tag a portion of the transcript in sync to the portion of the video; and
store information pertaining to the portion of the transcript marked by the user.

16. The computer program product of claim 15, the program instructions further causing the processor to transmit the information pertaining to the portion of the transcript marked by the user to one or more other users.

17. The computer program product of claim 8, the program instructions further causing the processor to identify one or more portions of the transcript in response to search criteria provided by the user.

18. The computer program product of claim 10, the program instructions further causing the processor to assign a tag to the one or more identified portions of the transcript.

19. The computer program product of claim 8, the program instructions further causing the processor to display to the user one or more documents referenced in the transcript of the video.

20. The computer program product of claim 8, wherein streaming the video to the user comprises streaming one or more portions of the video to the user.
